(19) United States
(12) Patent Application Publication
(10) Pub. No.: US 2026/0036536 A1
(43) Pub. Date: Feb. 5, 2026

(54) METHOD FOR DEFECT REVIEW MEASUREMENT ON A SUBSTRATE, APPARATUS FOR IMAGING A SUBSTRATE, AND METHOD OF OPERATING THEREOF

(71) Applicant: Applied Materials, Inc., Santa Clara, CA (US)

(72) Inventors: Bernhard G. MUELLER, Finsing (DE); Yong GAO, Fremont, CA (US); Peter NUNAN, Bethlehem, PA (US); Nikolai KNAUB, München (DE); Lingjia LI, Chengdu (CN)

(21) Appl. No.: 18/998,756

(22) PCT Filed: Aug. 18, 2022
(86) PCT No.: PCT/CN2022/113230

§ 371 Date: Jan. 27, 2025

(51) Int. Cl. G01N 23/2251; G06T 7/00; G06T 7/13; G06V 10/75; G06V 10/764

(52) U.S. Cl. CPC G01N 23/2251; G06T 7/001; G06T 7/13; G06V 10/764; G01N 2223/401; G01N 2223/6116; G06T 2207/10061; G06T 2207/30148; G06V 10/759; G06V 2201/06

(57) ABSTRACT

A method for defect classification is described. The method includes storing a plurality of defect classes in terms of a plurality of classification rules in a multi-dimensional feature space, wherein the plurality of classification rules, for each defect class of the plurality of defect classes, defines in the multi-dimensional feature space a boundary of a region associated with the defect class; receiving one or more electron beam image data associated with a plurality of defects detected in one or more display devices on a large area substrate under inspection; applying, by a processor, an automatic classifier to the electron beam image data, the automatic classifier based on the plurality of classification rules; and identifying the plurality of defects each classified with at least a first level of confidence based on at least one confidence threshold.

### BACKGROUND

### Field

The present disclosure relates to a method for a defect review (DR) measurement on substrates, particularly for display manufacturing, i.e. on large area substrates. Further, embodiments relate to a method for a defect review classification for display manufacturing. Embodiments of the present disclosure generally relate to automated inspection, and specifically to methods and systems for analysis of manufacturing defects.

### Description of the Related Art

In many applications, it is beneficial to inspect a substrate to monitor the quality of the substrate. For example, glass substrates on which layers of coating material are deposited are manufactured for the display market. Since defects may e.g. occur during the processing of the substrates, e.g. during the coating of the substrates, an inspection of the substrate for reviewing the defects and for monitoring the quality of the displays is beneficial.

Displays are often manufactured on large area substrates with continuously growing substrate sizes. Further, displays, such as TFT-displays, are subject to continuous improvement. The inspection of the substrate can be carried out by an optical system. However, defect review (DR) measurements, for example, DR of a TFT-array, are beneficially conducted with a higher resolution that cannot be provided with optical inspection anymore. A DR measurement can for example provide information related to a defect that has previously been detected. Accordingly, DR measurements are valuable for process control since countermeasures preventing or reducing the probability of a defect can be taken.

An automated defect classification (ADC) can be done based on optical defect images. However, the smaller design rules in modern display manufacturing are more yield sensitive for defects with a size of 10 μm or below. Optical images do not deliver sufficient information due to the reduced resolution.

Defect detection or redetection in a ‘Defect Review System’ can be provided by comparison of a reference image and a defect image, i.e. an image to be inspected. Defects are considered as a deviation between the reference image and the defect image exceeding a given threshold.

Automatic Defect Classification (ADC) techniques are used in inspection and measurement of defects on patterned wafers in the semiconductor industry. ADC techniques detect the existence of defects, as well as automatically classify the defects by type in order to provide more detailed feedback on the production process and to reduce the load on human inspectors. ADC techniques are used, for example, to distinguish among types of defects arising from particulate contaminants on a wafer surface and defects associated with irregularities in the microcircuit pattern, and may also identify specific types of particles and irregularities.

Substrates for display manufacturing are typically glass substrates having an area of, for example, 1 m² or above. High resolution images on such large substrates are very challenging per se, and most findings from the wafer industry are not applicable. Further, the options for DR measurement as provided on semiconductor wafers may not be suitable for large area substrates. Generally, manufacturing tolerances that are in the same order of magnitude or in close orders of magnitude as compared to defect sizes to be detected may result in a false defect detection or low threshold settings. Accordingly, an applicability of findings from the wafer industry is not given.

Accordingly, given e.g. the increasing demands on the quality of defect review, there is a need for an improved DR and defect classification, for example, without breaking the display substrates into smaller samples and allowing to continue the manufacturing process of the display substrates after the DR measurement.

### SUMMARY

In light of the above, a method for defect classification, a method of generating a plurality of classification rules, and an automated defect classification system are provided. Further aspects, advantages and features of the present disclosure are apparent from the description and the accompanying drawings.

According to an embodiment, a method for defect classification is provided. The method includes storing a plurality of defect classes in terms of a plurality of classification rules in a multi-dimensional feature space, wherein the plurality of classification rules, for each defect class of the plurality of defect classes, defines in the multi-dimensional feature space a boundary of a region associated with the defect class; receiving one or more electron beam image data associated with a plurality of defects detected in one or more display devices on a large area substrate under inspection; applying, by a processor, an automatic classifier to the electron beam image data, the automatic classifier based on the plurality of classification rules; and identifying the plurality of defects each classified with at least a first level of confidence based on at least one confidence threshold.

According to an embodiment, a method of generating a plurality of classification rules is provided. The method includes receiving a plurality of electron beam image data associated with a plurality of defects detected in one or more display devices on a large area substrate; receiving defect classes, each defect class associated with one or more of the plurality of electron beam image data; and generating the plurality of classification rules in a multi-dimensional feature space, wherein the plurality of classification rules, for each defect class of a plurality of defect classes, defines in the multi-dimensional feature space a boundary of a region associated with the defect class.

According to an embodiment, an automated defect classification system is provided. The system includes a memory comprising instructions and a processor, wherein the instructions, when executed by the processor, cause the automated defect classification system to execute a method according to any of the embodiments of the present disclosure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope, and may admit to other equally effective embodiments.

FIG. 1 shows a schematic illustration of a process of display manufacturing with an inline automated defect classification according to embodiments of the present disclosure.

FIG. 2 shows a side view of an apparatus for imaging portions of a substrate, according to embodiments described herein.

FIG. 3 shows a side view of another apparatus for imaging portions of a substrate according to embodiments described herein.

FIG. 4 shows a flow chart illustrating a method for defect classification on a large area substrate, e.g. for display manufacturing, according to embodiments of the present disclosure.

FIG. 5 is a schematic representation of a feature space for defect classification according to embodiments of the present disclosure.

FIG. 6 is a block diagram of an automated defect classification system according to embodiments of the present disclosure.

FIG. 7 is a schematic graph illustrating the purity vs. the reject level in accordance with embodiments of the present disclosure.

FIG. 8 is a block diagram of an exemplary computer system that may perform one or more of the operations described herein.

FIGS. 9A to 9D show images for illustrating an exemplary defect review measurement utilized for some embodiments according to the present disclosure.

FIG. 10 is an exemplary class image.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Reference will now be made in detail to the various exemplary embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. The intention is that the present disclosure includes such modifications and variations.

Within the following description of the drawings, the same reference numbers refer to the same components. Only the differences with respect to the individual embodiments are described. The structures shown in the drawings are not necessarily depicted true to scale but rather serve the better understanding of the embodiments.

Electron beam review (EBR), particularly for large area substrates, wherein the entire substrate or areas distributed over the entire substrate are measured such that, for example, a display to be manufactured is not destroyed during the review process or for the review process, is a comparably young technology. Resolutions of, for example, 20 nm or below, such as 10 nm or below are very challenging to achieve and previous findings from wafer imaging may not be suitable in light of the significant difference in substrate sizes. For example, a stage, i.e. a substrate table, may be beneficially suitable to be positioned in an arbitrary area of the entire substrate below an electron beam, and the positioning must be very precise over the large area. For large area substrates, the areas to be measured are larger and various areas may be further apart from each other, for example as compared to wafer imaging apparatuses. Accordingly, a simple upscaling cannot be successful, for example, due to the different throughput requirements. Yet further, manual or semi-automated processes may also not be suitable in light of the desired throughput as well as the repeatability of measuring positions distributed over the area of the large area substrate.

Further, manufacturing tolerances for display manufacturing on large area substrates are larger as compared to semiconductor manufacturing on wafers. Accordingly, acceptable deviations of an image at a first position relative to an image of a second position having the same pattern are larger as compared to semiconductor manufacturing. Accordingly, the size of a defect can be within the same order of magnitude as the acceptable deviations or the size of a defect is only one or two magnitudes larger as compared to the acceptable deviations. Generally, for display manufacturing as well as in the semiconductor industry, defect review can be based on image comparison and a threshold of the deviation of images. Such a comparison has limitations as soon as the defect size is closer to the size of acceptable deviations, for example, deviations based on the manufacturing tolerances. Accordingly, embodiments of the present disclosure particularly relate to defect review and defect classification for display manufacturing, e.g. to defect review on large area substrates.

Embodiments of the present disclosure provide for an automated defect classification (ADC) based on scanning electron microscopic images, which has not been possible for the display industry in the past. For the display industry, ADC has been provided based on optical defect images. However, the smaller design rules in modern display manufacturing are more yield sensitive for defects with a size of 10 μm or below. Optical images do not deliver sufficient information due to the reduced resolution. Embodiments of the present disclosure allow for utilization of scanning electron microscope (SEM) images from EBR and enable the ADC for volume production lines in display industry, particularly for inline SEM electron beam review on large area substrates and display devices provided on the large area substrates.

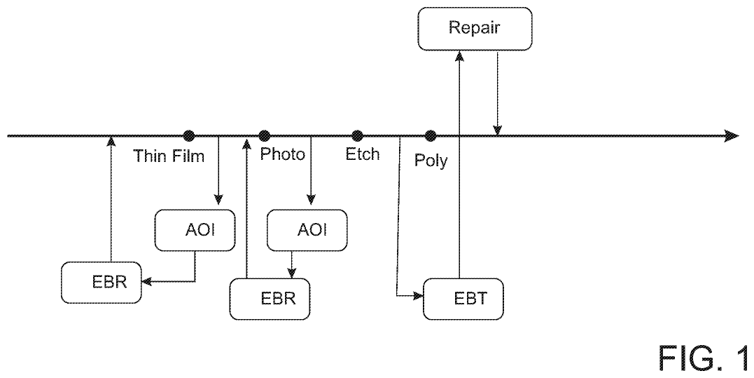

FIG. 1 shows a process flow of an exemplary display manufacturing and includes automated defect classification according to embodiments of the present disclosure. The yield management system can typically include one or more inspection operations after the processing operation. For example, a thin film deposition can be provided on a large area substrate, particularly a large area substrate having one or more structures provided thereon. Further substrate processing steps may include deposition of a photoresist, etching, structuring, and/or depositing of material layers, for example, polysilicon. After one or more of the substrate processing operations, an automated optical inspection (AOI) and/or an EBT test may be provided. An automated optical inspection utilizes light for detection of portions of the large area substrate. For example, the entire large area substrate can be inspected. The inspection may result in one or more substrate positions, at which an irregular structure or an irregular material characteristic occurs. Additionally or alternatively, an electron beam test (EBT) tool can test pixel defects, line defects, driver defects or other defects of a display on a large area substrate. In light of the larger field of view (FOV) of an electron beam test tool as compared to an electron-beam review tool, i.e. an SEM, the entire large area substrate can be tested. The test may result in one or more substrate positions, at which a defect may occur.

A method for defect review images may receive a list of defects or defect candidates. As described above, the large area substrate can be tested with an AOI tool to obtain the list of defects or defect candidates. Additionally or alternatively, the pixels of a display can be tested with a display test method. Pixel defects, line defects, driver defects or other defects can be tested with an electron beam test system and optical test system or other measurements, such as electrical measurements. Accordingly, defective pixel positions can be provided for the defect review measurement and/or can be provided to an apparatus for defect review measurement.

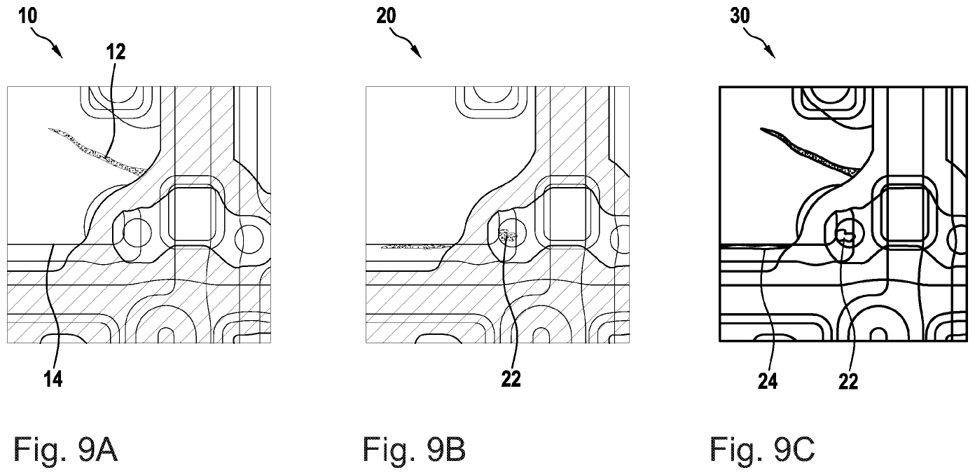

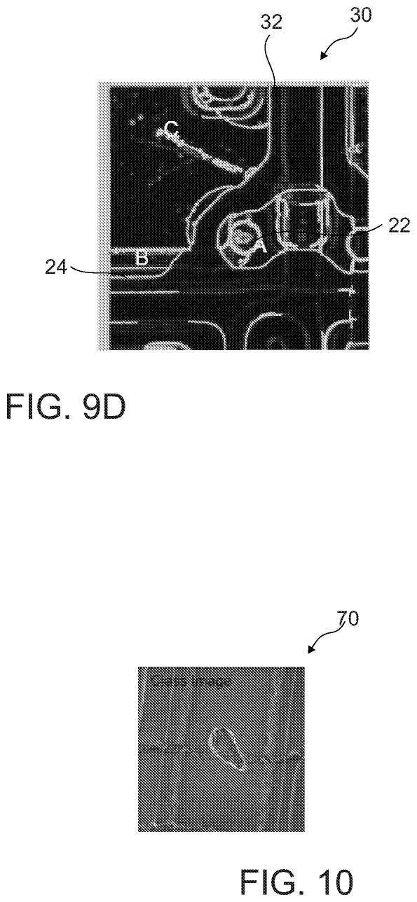

An area of the defective pixel is imaged to provide the defect image. A further area, e.g. a corresponding area of a neighboring pixel, is measured to provide the reference image. A defect review of defects from a previous metrology tool can be evaluated with a DR measurement. Due to the size of the substrates for display manufacturing and the resulting challenges for the manufacturing processes, locations for defect review measurements on large area substrates as described with respect to embodiments of the present disclosure can be distributed over the large area substrate. For example, a display may have 5 million pixels or above, such as about 8 million pixels. Large displays may include even higher number of pixels. For each pixel, at least an electrode for red, an electrode for green, and an electrode for blue (RGB) are provided. Accordingly, defects that are considered critical for the manufacturing process may occur over a very large area. As described with respect to FIGS. 9A to 9D, embodiments can include providing a DR measurement based on a first operation with a mask pattern and a subsequent second operation without the mask pattern. The DR measurement is provided at a structure of a defect image and with a reference image.

According to some embodiments, which can be combined with other embodiments described herein, the defect image is generated at a defective pixel on the substrate and the reference image is generated at a pixel neighboring the defective pixel or at a pixel adjacent to the defective pixel. A defect review measurement can be repeated on one or more areas of the substrate, the areas being distributed over at least 1 m².

According to some embodiments, which can be combined with other embodiments described herein, substrates described herein relate to large area substrates, in particular large area substrates for the display market. According to some embodiments, large area substrates or respective substrate supports may have a size of at least 1 m², such as at least 1.375 m². The size may be from about 1.375 m² (1100 mm×1250 mm-Gen 5) to about 9 m², more specifically from about 2 m² to about 9 m² or even up to 12 m². The substrates or substrate receiving areas, for which the structures, apparatuses, and methods according to embodiments described herein are provided, can be large area substrates as described herein. For instance, a large area substrate or carrier can be GEN 5, which corresponds to about 1.375 m² substrates (1.1 m×1.25 m), GEN 7.5, which corresponds to about 4.39 m² substrates (1.95 m×2.25 m), GEN 8.5, which corresponds to about 5.7 m² substrates (2.2 m×2.5 m), or even GEN 10, which corresponds to about 9 m² substrates (2.88 m×3130 m). Even larger generations such as GEN 11 and GEN 12 and corresponding substrate areas can similarly be implemented. It has to be considered that the substrate size generations provide fixed industry standards even though a GEN 5 substrate may slightly deviate in size from one display manufacturer to another display manufacturer. Embodiments of an apparatus for testing may for example have a GEN 5 substrate support or GEN 5 substrate receiving area such that GEN 5 substrates of many display manufacturers may be supportable by the support. The same applies to other substrate size generations.

According to embodiments of the present disclosure, an electron-beam review can be provided on the large area substrate, particularly without cutting the large area substrate into smaller pieces. The electron-beam review can provide images, particularly SEM images, of the one or more substrate positions that are provided, for example, by the automated optical inspection tool or the electron-beam test tool. The SEM images can be utilized for defect review and, particularly defect classification.

According to some embodiments, which can be combined with other embodiments described herein, the defect classification can be utilized for root cause analysis, wherein the substrate processing process can be adapted according to defect classes that are detected during defect classification. A defect classification can include different types of defects, different sizes of the defect, and/or interconnection of a defect to other patterns or structures on a display. The properties associated with a defect can be utilized to distinguish between defects that are referred to as a killer defect or not as a killer defect. A killer defect can be understood as a defect that results in a non-functioning or non-usable display.

According to some embodiments, which can be combined with other embodiments described herein, a decision if a defect is a killer defect can be made, for example, after the display manufacturing process is fully completed and the display can be turned on, after some processing steps, and/or after the defect is manufactured to a state, in which the pixels can be driven. For example, an EBT test can be provided on a substrate having displays in a state that the displays can be driven. According to some embodiments, which can be combined with other embodiments describe herein, a defective pixel, which is directly visible, can be correlated to a recorded defect review data from EBR and a corresponding defect classification. According to some embodiments, a defect can be determined to be a killer defect by correlating the EBR data with the EBT data. EBT detects electrical defects which are killer defects for the most part.

According to some embodiments, which can be combined with other embodiments described herein, an ADC from electron beam image data on a display device may be utilized for process control. For example, the ADC results can be fed back to the process and the process recipe can be adapted. A statistical evaluation of the defect type distribution and general process and equipment optimization by SPC (statistical process control) can be provided.

FIG. 1 shows EBR measurement operations after different manufacturing operations of a display device on a large area substrate. The EBR information can be fed back to the processing operation for process control. Further, an EBT measurement is shown, wherein a substrate can be forwarded to a repair station after, for example, one or more killer defects have been found.

According to some embodiments, which can be combined with other embodiments described herein, a defect type may be selected from the group consisting of: a scratch, a particle, a bridge, and an open. The defect size can be provided in size categories like small, medium or large, wherein the size category may correspond to a different absolute dimension for each of the defect types. As a further characteristic of a defect, a connection to another pattern may occur or may not occur. Further defect properties can be provided.

Particularly for killer defects, a repair tool can be provided in a display fab equipment to correct and/or repair a defect between processing operations of the large area substrate. For example, a short or a bridge may be cut with an ion beam or a laser. After defect classification the large area substrate can be provided to a further processing tool. According to embodiments of the present disclosure, defect classification based on electron-beam review images on a large area substrate can be provided in line of a display manufacturing process. Particularly, the defect classification can be provided after processing the large area substrate in a first production chamber and before further processing the large area substrate in the second production chamber. Accordingly, the overall yield can be improved. The yield can be improved by correcting or repairing a defect at the end of or between production operations. The yield can be improved by associating a classified defect with the root cause for the defect and an adaptation of the manufacturing conditions for subsequent large area substrates to be processed.

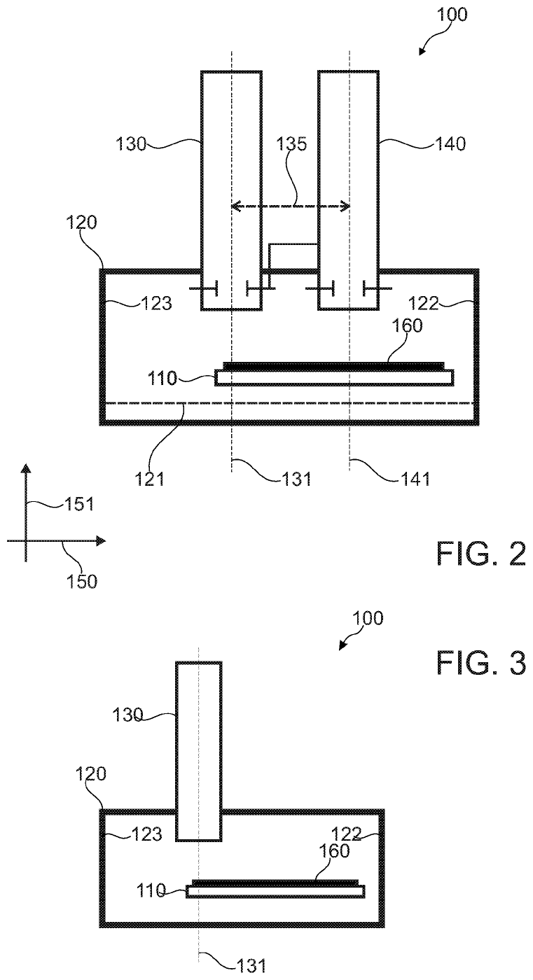

According to embodiments of the present disclosure, an electron beam review tool for large area substrates, for example, an SEM tool configured to generate images on a large area substrate, can be provided for defect classification. FIG. 2 shows an electron beam review tool. The electron beam review tool includes a substrate support 110 that extends along the x-direction 150. In the drawing plane of FIG. 2, the x-direction 150 is a left-right direction. A substrate 160 is disposed on the substrate support 110. The substrate support 110 is movable along the x-direction 150 to displace the substrate 160 in the vacuum chamber 120 relative to the first imaging charged particle beam microscope 130 and the second imaging charged particle beam microscope 140. Each of the first imaging charged particle beam microscope 130 and the second imaging charged particle beam microscope can generate an SEM image of a small portion of the large area substrate. According to some embodiments, which can be combined with other embodiments described herein, the field of view of an imaging charged particle beam microscope for methods and apparatuses according to the present disclosure can have a dimension of 500 μm or below and/or a dimension of 5 μm or above. The resolution of the image can be about 100 nm or below, such as 20 nm or below, for example, 10 nm or below.

An area of the substrate 160 can be positioned below the first imaging charged particle beam microscope 130 or below the second imaging charged particle beam microscope 140 for DR measurement. The area may include a structure for DR measurement contained in or on a coated layer on the substrate. The substrate support 110 may also be movable along a y-direction (not shown) so that the substrate 160 can be moved along the y-direction. By suitably displacing the substrate support 110 holding the substrate 160 within the vacuum chamber 120, portions along the entire extent of the substrate 160 may be measured inside the vacuum chamber 120.

The first imaging charged particle beam microscope 130 can be distanced from the second imaging charged particle beam microscope 140 along the x-direction 150 by a distance 135. In the embodiment illustrated in FIG. 2, the distance 135 is a distance between a center of the first imaging charged particle beam microscope 130 and a center of the second imaging charged particle beam microscope 140. In particular, the distance 135 is a distance, along the x-direction 150, between a first optical axis 131 defined by the first imaging charged particle beam microscope and a second optical axis 141 defined by the second imaging charged particle beam microscope 140. The first optical axis 131 and the second optical axis 141 extend along a z-direction 151. The first optical axis 131 may for example be defined by the objective lens of the first imaging charged particle beam microscope 130. Similarly, the second optical axis 141 may for example be defined by the objective lens of the second imaging charged particle beam microscope 140.

As further shown in FIG. 2, the vacuum chamber 120 has an inner width 121 along the x-direction 150. The inner width 121 may be a distance obtained when traversing the vacuum chamber 120 along the x-direction from left-hand wall 123 of the vacuum chamber 120 to right-hand wall 122 of the vacuum chamber 120. An aspect of the disclosure relates to the dimensions of the apparatus 100 with respect to the e.g. x-direction 150. According to embodiments, the distance 135 along the x-direction 150 between the first imaging charged particle beam microscope 130 and the second imaging charged particle beam microscope 140 may be at least 30 cm, such as at least 40 cm. According to further embodiments, which can be combined with other embodiments described herein, the inner width 121 of the vacuum chamber 120 may lie in the range from 250% to 450% of the distance 135 between the first imaging charged particle beam microscope 130 and the second imaging charged particle beam microscope 140.

Embodiments described herein may provide an apparatus for imaging portions of a substrate. The substrate is processed as a whole in the vacuum chamber. In particular, embodiments described herein do not require breaking the substrate or etching the surface of the substrate. Accordingly, a high-resolution image for defect review measurement can be provided. An advantage of having a vacuum chamber with reduced dimensions, as provided by some embodiments described herein, is that one or more vibrations of the vacuum chamber may be reduced, since the level of vibration increases as a function of the size of the vacuum chamber. Accordingly, the vibration amplitude of the substrate may be advantageously reduced as well.

The exemplary first imaging charged particle beam microscope and the second imaging charged particle beam microscope have a distance along the first direction in the range from 30% to 70% of the first receiving area dimension of the substrate receiving area. More particularly, the distance along the first direction may lie in the range from 40% to 60% of the first receiving area dimension, e.g. about 50% of the first receiving area dimension. For example, referring to the embodiment illustrated in FIG. 2, the distance along the first direction may refer to the distance 135 between the first imaging charged particle beam microscope 130 and the second imaging charged particle beam microscope 140. In the exemplary embodiment illustrated in FIG. 2, the distance 135 is approximately 50% of the width of the substrate receiving area.

The substrate support may be movable in the vacuum chamber with respect to the first imaging charged particle beam microscope and/or with respect to the second imaging charged particle beam microscope. According to embodiments, which can be combined with other embodiments described herein, the second imaging charged particle beam microscope is distanced from the first imaging charged particle beam microscope by a distance of at least 30 cm, more particularly a distance of at least 40 cm, such as about 50% of the first receiving area dimension. An advantage of having a minimum distance between the first imaging charged particle beam microscope and the second imaging charged particle beam microscope, i.e. a distance that is larger than merely duplicating two imaging charged particle beam microscopes next to each other for redundancy, e.g. two SEMS next to each other, is that the distance over which a substrate inspected by the apparatus travels is reduced. This allows for a reduced size of the vacuum chamber, so that the vibrations of the vacuum chamber can be advantageously reduced as well.

According to embodiments, an apparatus for imaging a portion of a substrate can be provided for defect review and defect classification. The apparatus includes a vacuum chamber and a substrate support arranged in the vacuum chamber. According to some embodiments, which can be combined with other embodiments described herein, the substrate support may optionally provide a substrate receiving area of at least 1 m².

FIG. 3 shows a side view of another apparatus for imaging portions of a substrate, according to embodiments described herein. The apparatus 100 includes a vacuum chamber 120. The apparatus 100 further includes a substrate support 110 on which a substrate 160 may be supported. The apparatus 100 includes a first imaging charged particle beam microscope 130. Contrary to FIG. 2, FIG. 3 shows a single imaging charged particle beam microscope provided above the substrate support 110. Even though this may result in reduced imaging capability, for example reduced resolution, the resulting resolution may be sufficient for some DR measurements. Further, for semiconductor wafer applications in which the defect size of the defect to be detected is small as compared to the acceptable manufacturing tolerances, an apparatus for imaging portions of the substrate having a single imaging charged particle beam microscope can be provided. Similar to FIG. 2, the apparatus shown in FIG. 3 may include a controller and a deflection assembly. The controller can be connected to the substrate support, and particularly a displacement unit of the substrate support. Further, the controller can be connected to the deflection assembly of the imaging charged particle beam microscope.

Defect review measurements are typically provided on various areas of a substrate, such as a wafer in semiconductor manufacturing or such as a large area glass substrate for display manufacturing. The defect review of a structure can, thus, be analyzed statistically over the entire substrate area and over a plurality of processed substrates. For a small substrate, such as a wafer, this may be done with methods known from the semiconductor industry with sufficient throughput. A matching of measurement capabilities is provided tool-to-tool in the semiconductor industry. For electron beam review (EBR) of display substrates, two imaging charged particle beam microscope in one apparatus (see FIG. 2) can be matched relative to each other. This relates to relative positions as well as measurement capabilities. A single column apparatus (see FIG. 3) may avoid the matching of columns in one system while accepting a reduced resolution. A multiple column apparatus may beneficially include a column matching and has an increased resolution.

According to some embodiments, which can be combined with other embodiments described herein, a method of operating an apparatus for imaging of the present disclosure can include matching a first coordinate system on the large area substrate of the first imaging charged particle beam microscope with a second coordinate system on the large area substrate of the second imaging charged particle beam microscope.

Both options, i.e. a single column approach and multi-column approach, allow for the improved DR measurement processes described herein, wherein sufficient detection sensitivity as well as sufficient throughput is provided, particularly also on large area substrates. According to embodiments of the present disclosure, DR measurements as described herein can be provided in various areas of the large area substrate. For example, two or more areas, such as 5 areas to 100 areas can be distributed over the substrate.

An imaging charged particle beam microscope, as used herein, may be adapted for generating a low-energy charged particle beam having a landing energy of 2 keV or below, particularly of 1 keV or below. Compared to high-energy beams, low energy beams do not impact or deteriorate a display backplane structure during defect review measurements. According to yet further embodiments, which can be combined with other embodiments described herein, the charged particle energy, for example the electron energy, can be increased to 5 keV or above, such as 10 keV or above between the particle beam source and the substrate. Accelerating the charged particles within the column reduces interaction between the charged particles, reduces aberrations of electro-optical components, and, thus, improves the resolution of the imaging scanning charged particle beam microscope.

According to a yet further embodiment, which can be combined with other embodiments described herein, the term “substrate” as used herein embraces both inflexible substrates, e.g., a glass substrate, or a glass plate, and flexible substrates, such as a web or a foil. The substrate may be a coated substrate, wherein one or more thin layers of materials are coated or deposited on the substrate, for example by a physical vapor deposition (PVD) process or a chemical vapor deposition process (CVD). A substrate for display manufacturing typically includes an insulating material, for example glass. Accordingly, contrary to semiconductor wafer SEMs, an apparatus for imaging portions of a large area substrate does not allow for biasing the substrate. According to embodiments described herein, which can be combined with other embodiments described herein, the substrate is grounded. The substrate cannot be biased to a potential for influencing the landing energy or other electro-optical aspects of the scanning electron beam microscope. This is a further example of the differences between an EBR system for large area substrates and semiconductor wafer SEM inspection. This may further result in problems with electrostatic discharge (ESD) upon substrate handling on the substrate support. Accordingly, it can be seen that wafer inspection schemes may not easily be applied for DR measurement of substrate for display manufacturing.

According to yet further embodiments, which can be combined with other embodiments described herein, defect review measurements on large area displays for display manufacturing may further distinguish over semiconductor wafer DR based on the scanning technique. Generally, an analog scanning technique and a digital scanning technique may be distinguished. An analog scanning technique may include an analog sawtooth signal provided to the scanning deflector assembly with a predetermined frequency. The sawtooth signal can be combined with a continuous or quasi-continuous substrate movement to a scan area of the substrate. A digital scanning technique provides discrete values for x-positioning and y-positioning of the charged particle beam on the substrate and the individual pixels of a scanned image are addressed pixel-per-pixel by coordinate values, i.e. digitally. An analog scanning technique (“flying stage”) that may be considered preferable for semiconductor wafer SEM inspection due to the scanning speed and the reduced complexity, is not beneficial for DR measurement on large area substrates. Due to the size of the substrate, the areas to be scanned are scanned digitally, i.e. by providing a list of the desired beam position coordinates. That is, the images are scanned with a digital scanning technique, i.e. a digital scanner. Due to the size of the substrate, such a scanning process provides better throughput and accuracy.

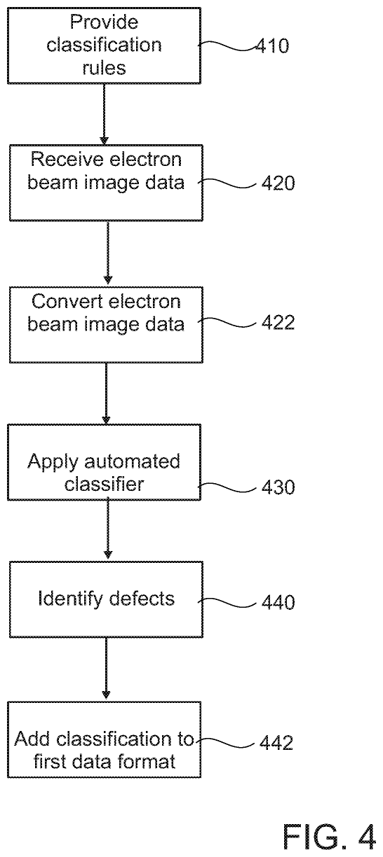

According to an embodiment of the present disclosure, a method for defect classification is provided. As indicated by operation 410 in FIG. 4, a plurality of defect classes is stored, for example, in the memory, or provided in terms of a plurality of classification rules in a multi-dimensional feature space. The plurality of classification rules, for each defect class of the plurality of defect classes, defines in the multi-dimensional feature space a boundary of a region associated with the defect class. One or more electron beam image data are received and are associated with a plurality of defects detected in one or more display devices on a large area substrate under inspection (see, for example, operation 420). At operation 430, an automatic classifier is applied, by a processor, to the electron beam image data. The automatic classifier is based on the plurality of classification rules. At operation 440, a plurality of defects each classified with at least a first level of confidence based on the at least one confidence threshold is identified. According to some embodiments, which can be combined with other embodiments described herein, the electron beam image data can be converted, by an interface algorithm, to a second data format for applying the automatic classifier (see operation 422).

For example, the first data format, which is received during operation 420, can be converted to the second data format at operation 422. The first data format can include a reference image and a defect image. According to yet further optional modifications, the first data format may further include a class image. According to some embodiments, which can be combined with other embodiments described herein, and as illustrated by operation 442, a method may further include adding, by the interface algorithm, a defect classification for each defect of the plurality of defects identified with at least the first level of confidence to the first data format.

Embodiments of the present disclosure provide electron beam image data, for example, a result file, which may include a high-resolution SEM image per predefined substrate location. The electron beam image data or the result file can be provided by an EBR tool. An interface algorithm, for example, provided by an interface software converts the data from a first data format associated with data from display manufacturing to a second data format. The second data format can be provided to an automated defect classification (ADC) server. The ADC server provides automatic defect classification based on machine learning algorithms, for example, utilizing artificial intelligence

According to embodiments, a machine learning algorithm may combine multiclass classifiers and single class classifiers. Further, the purity of classification can be utilized for automated defect classification. Purity of classification may be the percentage of the remaining defects (e.g., defects found by the ADC system to be classifiable and not rejected) that are classified correctly. A system operator may specify a classification performance measure, such as a desired purity and/or a certain maximum rejection rate. The classification performance measure may be a percentage of defects that the ADC system is unable to classify with confidence and therefore returns for classification by a human expert (e.g., system operator).

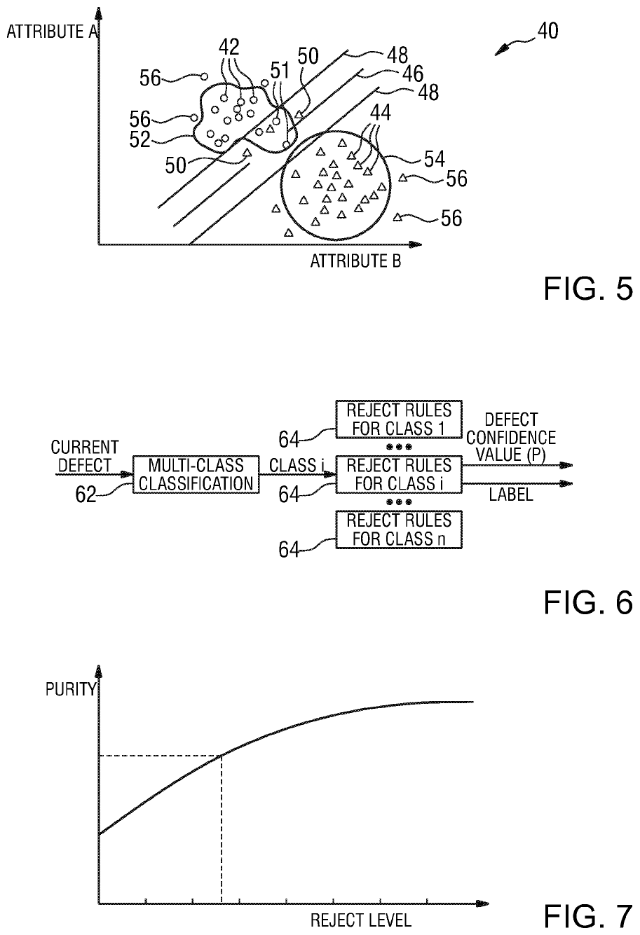

FIG. 5 is an exemplary schematic representation of a feature space 40 to which a set of defects 42, 44, 50, 51, 56 is mapped, in accordance with an embodiment of the present disclosure. Although the feature space 40 is represented as being two-dimensional, the classification processes are typically carried out in spaces of higher dimensionality. The defects in FIG. 5 are assumed to belong to two different classes, one associated with defects 42 (which will be referred to below as “Class I”), and the other associated with defects 44 (which will be referred to below as “Class II”). Defects 42 are bounded in the feature space 40 by a border 52, while defects 44 are bounded in the feature space 40 by a border 54. The borders may overlap.

An ADC machine can apply two types of classifiers to classify the defects: a multi-class classifier and at least one single-class classifier. The multi-class classifier distinguishes between Classes I and II. For example, the multi-class classifier can be a binary classifier, which defines a boundary 46 between the regions associated with the two classes. In some embodiments, the ADC machine performs multi-class classification by superposing multiple binary classifiers, each corresponding to a different pair of classes, and assigning each defect to the class that receives the most positive votes from the multiple binary classifiers. Once defects have been classified by the multi-class classifier, single-class classifiers, represented by borders 52 and 54, identify the defects that can be reliably assigned to the respective class, while rejecting the defects outside the borders as “unknown.”

In some embodiments, a system operator of the ADC machine provides confidence thresholds, which determine the loci of the boundaries of the regions in feature space 40 that are associated with the defect classes. Setting the confidence threshold for multi-class classification can be equivalent to placing the borders 48 on either side of boundary 46. In some embodiments, the higher the confidence threshold, the farther apart borders 48 will be. The ADC machine may reject defects 51, which are located between borders 48 but within border 52 or 54, as “undecidable,” because the ADC machine may be unable to automatically assign such defects to one class or the other with the required level of confidence. Undecidable defects may be decided by a human operator or may be decided by a different classification module having different input values.

In some embodiments, the confidence thresholds control the shape of a border of the single-class classifiers. The shape may refer to the geometrical form of a border, and may also refer to the extent of the border. The shape may be associated with a parameter of a kernel function that is used in implementing the single-class classifiers. For each value of the confidence threshold, the ADC machine chooses an optimal value of the parameter. In some embodiments, the extent of a border shrinks as the confidence threshold increases, and the geometrical form of the border may also change as different kernel parameter values are selected.

Referring back to FIG. 5, defects 56 fall outside borders 52 and 54 and may therefore be classified as “unknown” defects, although defects 56 may have been decided by the multi-class classifier. Defects 50, which are both outside borders 52 and 54, and between borders 48, are also considered “unknown,” because defects 50 fall outside borders 52 and 54 In some embodiments, setting a lower confidence threshold could expand border 52 and/or 54 sufficiently to contain the defects 50 and/or defects 56, resulting in the rejection of fewer defects by the ADC machine. However, by setting a lower confidence level, more classification errors may be made by the ADC machine, thus reducing the purity of classification. In some embodiments, increasing the confidence threshold may enhance the purity of classification, but may result in a higher rejection rate (more defects will be rejected by the ADC machine as unknown).

FIG. 6 is an exemplary block diagram of a classifier. The classifier can include multi-class classifier 62 and one or more single-class classifiers 64. The classifier can include a single-class classifier 64 for each defect class in an ADC system. In another embodiment, a single-class classifier 64 can be used for more than one defect class. Multi-class classifier 62 can process the vector of feature values for each defect to select a defect class for the defect or to reject the defect as undecidable or unknown. In one embodiment, multi-class classifier 62 is a support vector machine. In an alternate embodiment, multi-class classifier 62 is a classifier with similar properties to a support vector machine. Single-class classifier 64 can check the features of a defect against one or more rejection rules for the class or classes represented by single-class classifier 64.

FIG. 7 is an exemplary schematic graph of classification purity as a function of a rejection rate, in accordance with an embodiment of the present disclosure. An ADC machine may generate a graph based on actual results of classification of training data. For this purpose, the ADC machine can compare automatic classification results over a set of defects in the training data to “gold standard” (verification set) visual classification performed by a human inspector. The comparison may be performed for different confidence thresholds (with correspondingly different rejection rates). When all defects are automatically classified by the ADC machine with zero rejection rate, the purity of classification is low, since the machine is required to classify many questionable defects. However, choosing a high rejection rate may give high purity of classification, but may result in requiring the human inspector to spend a larger amount of time in visual classification of defects that are classified as “unknown” by the ADC machine.

An operator (e.g., human inspector) of the ADC machine may use a graph as shown in FIG. 5 to choose a rejection rate that will give the desired purity level or to assess the purity of classification that will result from setting a certain rejection rate.

Embodiments of the present disclosure provide an ADC system using a multi-class classifier and a single-class classifier. A multi-class classifier partitions a multi-dimensional feature space among multiple defect classes, and assigns each defect to one of the classes depending on the location of the defect within the feature space. The multi-class classifier identifies defects in overlap areas between the classes as non-decidable defects. The multi-class classifier may identify the defects in overlap areas by using a confidence threshold. For each defect class, a single-class classifier applies class-specific rules to identify defects belonging to the defect class and defects not in the class. Defects not in the class may be identified using a confidence threshold for the class, and may be identified as unknown defects. The single-class and multi-class classifiers are used together in classifying defects with high purity. The extent of the outer borders and overlap areas of the different classes are adjusted by means of variable confidence thresholds, in order to maximize purity while keeping the rejection rate no greater than a predefined threshold.

The confidence thresholds for the single-class classifiers (to distinguish between known and unknown defects) and for the multi-class classifier (to distinguish between decidable and non-decidable defects) can be adjusted during a training process using a set of defects that have been manually pre-classified by a human operator. The result of the training process can be a set of classification rules (also referred to as rejection rules) which define the boundaries in a feature space of each defect class. The set of classification rules can define the respective range of inspection feature values that characterize the class. The classification rules also provide a confidence measure that gives the level of confidence associated with each single-class or multi-class classification of a defect as a function of the location of the defect in the feature space.

Embodiments of the present disclosure may include for applying the automatic classifier: applying a multi-class classifier to the electron beam image data to classify the plurality of defects and applying a single-class classifier to identify the plurality of defects with the at least one confidence threshold. For example, setting a purity level and/or a confidence threshold to adapt the rejection rate can be provided. In classification of actual production defects whose classification is unknown, the confidence thresholds for each classifier may then be chosen in order to achieve the desired level of performance.

In embodiments of the present disclosure, defects that are rejected by the automatic classifiers (e.g., classified as non-decidable or unknown) are passed to one or more other inspection modalities, different from the one used for generating the first classification results, for classification to a defect class, resulting in second classification results. In one embodiment, the inspection modality is a human inspector, who assigns the rejected defects to the appropriate defect classes. In an alternate embodiment, the rejected defects are classified based on additional inspection data (e.g., X-ray inspection data, etc.) that provides additional information on the materials residing at and/or near the locations of the defects. The updated defect assignments for the rejected defects (second classification results) can be passed back to the ADC system. In one embodiment, the ADC system integrates the updated defect assignments (second classification results) with the automatically-classified defects (first classification results) into a combined data set. The ADC system can thus present a complete, unified report of defect distribution in a set of samples. Because of the high purity of the automatic classification results, a unified report can provide the system operator with the most comprehensive and accurate view possible of defect distribution.

In some embodiments, the second classification results, together with the corresponding defect images, may be used in refining the automatic classifiers. For example, the multi-class classifiers for defects that occur commonly in the pre-classified training set will typically have high accuracy and purity, while the classifiers for less common defect classes will have lower accuracy and higher rejection rates (since the classes are not well characterized in training data because of the classes' low defect count). The second classification results can be particularly useful in refining the classifiers for the less common defect classes. Once a sufficient defect count is accumulated for the less common defect classes, the less common defect classes can be added to a training set, resulting in an improvement in the accuracy and purity for the less common defect classes. As a consequence of the addition of the less common defect classes, the confidence level for each defect class may also increase and eventually reduce the number of rejected defects.

According to embodiments of the present disclosure, automated defect classification (ADC) can be provided for the display industry. According to some embodiments, which can be combined with other embodiments described herein, a large area substrate having one or more display devices provided thereon can be measured or inspected with at least one of an automated optical inspection tool or an electron-beam testing tool to obtain a plurality of positions associated with a potential defect. Accordingly, defect coordinates can be provided to an EBR tool. The EBR tool can determine high resolution defect images as exemplarily described with respect to FIGS. 9A to 9D below. According to some embodiments, which can be combined with other embodiments described herein, additional defect information like material, size, and/or connection to an adjacent pattern may be provided. According to some embodiments, which can be combined with other embodiments described herein, electron beam image data can provide information on material differences. According to some modifications, the electron beam image data can include the material of areas in an image. For example, the material of a particle, i.e. a contamination, can be included in the electron beam, image date. According to some embodiments, an EDX (energy dispersive X-ray spectroscopy) measurement can be provided with an electron beam microscope.

The EBR tool can provide a result file, i.e. electron beam image data with optional additional information, in a first data format. The result file includes high-resolution SEM images. The high-resolution SEM images can be provided per substrate location, determined by the EBR tool. An interface algorithm, for example, an interface software, converts the first data format into the second data format for automated defect classification by an ADC server. The ADC server provides for automated defect classification with machine learning algorithms as described above. The results of the classification can be provided, for example, to the interface algorithm, to add the defect classification data to the first data format. The updated information can be reported to a host, for example, a display manufacturing fab network. The defect classification is used for processing tool and yield optimization.

According to some embodiments, which can be combined with other embodiments described herein, the interface algorithm may add ADC results to the first data format. For example, defect types, defect properties, defect locations (i.e. exact defect locations), periodicity of defects, defect shapes (e.g. roundness) can be provided in the first data format. Respective variables may be pre-existing in the first data format and values are provided by the interface algorithm. Respective data fields, e.g. variables, might also be added to the first data format.

According to some embodiments, which can be combined with other embodiments described herein, in-line automated defect classification is enabled. For example, large area substrate processing, i.e. display manufacturing, may include loading a large area substrate having one or more structures of the one or more display devices from a first production chamber into a vacuum chamber having an electron beam microscope coupled to the vacuum chamber configured to measure electron beam images for the one or more electron beam image data. After generation of the SEM image, the large area substrate, i.e. the entire large area substrate can be loaded from the vacuum chamber of the EBR tool directly or indirectly into a further production chamber. According to some embodiments, which can be combined with other embodiments described herein, the substrate may be loaded into a repair station, particularly after determining a killer defect, for example with an EBT tool, wherein defects might be corrected.

Embodiments of the present disclosure may further include compensating of defect locations, i.e. defect location offsets or defect location arrows, which have been provided by a previous inspection system, such as an AOI tool or an EBT tool.

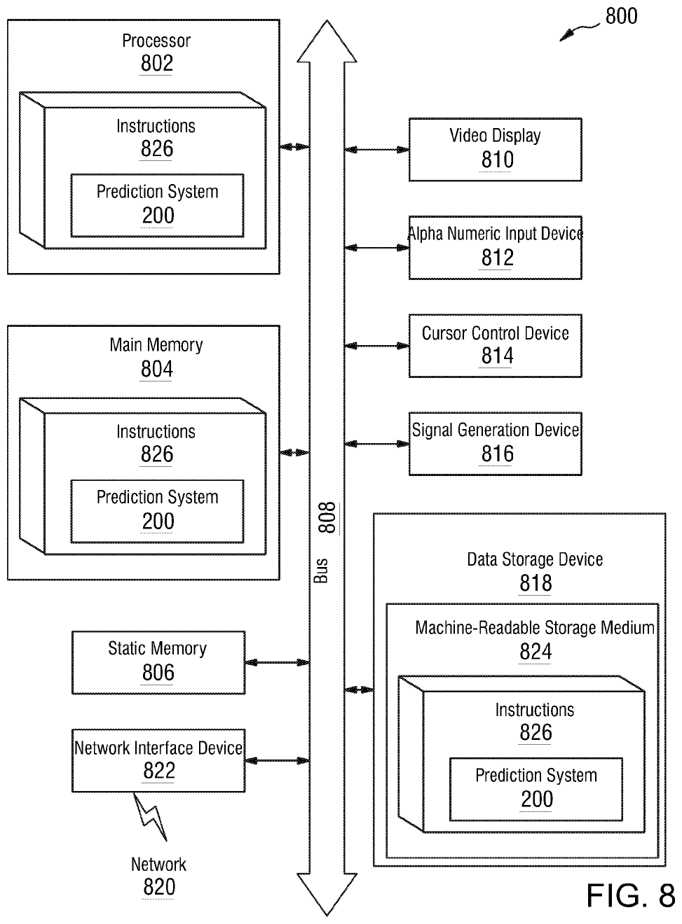

FIG. 8 illustrates a diagram of an automated defect classification system in the exemplary form of a machine, such as a computer system 800 within which a set of instructions, for causing the machine to perform any one or more of the methodologies and inspection methods discussed herein, may be executed. The machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the embodiments of the present disclosure.

The exemplary computer system 800 includes a processing device (processor 802), a main memory 804 (e.g., read-only memory (ROM), flash memory, dynamic random access memory (DRAM) such as synchronous DRAM (SDRAM), double data rate SDRAM (DDR SDRAM), or Rambus DRAM (RDRAM), etc.), a static memory 806 (e.g., flash memory, static random access memory (SRAM), etc.), and a data storage device 818, which communicate with each other via a bus 808.

Processor 802 represents one or more general-purpose processing devices such as a microprocessor, central processing unit, or the like. More particularly, the processor 802 may be a complex instruction set computing (CISC) micro-processor, reduced instruction set computing (RISC) micro-processor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations discussed herein. The computer system 800 may further include a network interface device 822. The computer system 800 may also include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 may include a computer-readable storage medium 824 on which one or more sets of instructions 826 are stored (e.g., software) embodying any one or more of the methodologies or functions described herein. The instructions 826 may also reside, completely or at least partially, within the main memory 804 and/or within the processor 802 during execution thereof by the computer system 800, the main memory 804 and the processor 802 also constituting computer-readable storage media. The instructions 826 can include instructions for integration of automatic and manual defect classification and/or a software library containing methods that call instructions for integration of automatic defect classification according to embodiments of the present disclosure.

FIGS. 9A to 9D show an exemplary embodiment of a method for defect review measurement, which may be utilized as electron beam image data for automated defect classification according to embodiments described herein. FIG. 9A shows a reference image 10. For example, the image can include a portion of a thin-film transistor of a pixel of a display. The image can be a scanning electron microscope image. For example, signal electrons generated upon impingement of primary electrons on the substrate are measured, i.e. the signal intensity can be measured. The intensity signal of the signal electrons can be displayed to generate the image. The reference image 10 shows a structure 14. The structure 14 corresponds to the structure manufactured during display manufacturing. According to some embodiments, which can be combined with other embodiments described herein, the reference image 10 may also include a feature 12 (see also reference numeral C in FIG. 7A). The feature 12 may be an undesired feature or an odd feature, which may not cause a defect but which is not intended for a perfectly manufactured structure 14.

FIG. 9B shows a defect image. The defect image includes the defect 22. A comparison between the reference image 10 and the defect image 20 is calculated. For example, the comparison image 30 is generated by a calculated brightness difference between the reference image 10 and the defect image 20. For example, an exactly matching defect image and reference image would result in a black comparison image, i.e. an image with no deviations. A difference between the reference image and the defect image appears as a bright spot, i.e. a deviation in brightness. For example, an absolute value of a difference of the reference image and the defect image can be calculated and/or plotted. The larger the deviation of the intensity signals, the larger the absolute difference and, thus, the brighter the area in the comparison image. According to some embodiments, which can be combined with other embodiments described herein, the comparison image may additionally or alternatively be generated by filters and further image processing routines, wherein the defect image and the reference image are compared.

A mask pattern 32, as illustrated in FIG. 9D, is overlaid on the comparison image 30. The mask pattern 32 is generated from the structure 14 of the reference image 10. According to embodiments of the present disclosure, the structure can include one or more features selected from the group consisting of: via, lines, trenches, connections, material boundaries, etched layer structures or the like. According to some embodiments, which can be combined with other embodiments described herein, the structure can be a portion of the thin-film transistor or another transistor for operating a pixel of a display. According to some embodiments, which can be combined with other embodiments described herein, the mask pattern 32 is generated by a pattern recognition method.

According to some embodiments, which can be combined with other embodiments described herein, the mask pattern 32 may include the feature 12, i.e. the odd feature of the reference image 10. Since the feature 12 is not intended, it may result in a brightness difference between the reference image and the defect image. Yet, since the reference image does not include a defect, a brightness difference corresponding to the feature 12 may result in an incorrect defect detection. The comparison image 30 is masked by the mask pattern 32 and the regions of the mask pattern are disregarded. Accordingly, the mask pattern including the feature 12 prevents incorrect defect detection for the odd feature.

Additionally or alternatively, a brightness difference 24 resulting from manufacturing tolerances, such as an edge roughness or other manufacturing tolerances, that may generate false defect detection in the comparison image 30, is masked by the mask pattern 32. Accordingly, acceptable deviations of an image at a first position, for example, the reference image 10, relative to an image of a second position, for example, the defect image 20 having the same pattern, may not result in a defect alarm, since the acceptable deviation is masked by the mask pattern 32.

As shown in FIG. 9C, a defect 22 (see also reference numeral A in FIG. 7C) shows a brightness difference between the reference image 10 and the defect image 20. The defect 22 is outside the mask pattern 32. A comparison of the defect image and the reference image in regions outside the mask pattern is utilized to detect the defect 22. According to some embodiments, which can be combined with other embodiments described herein, the best defect candidate or the best defect candidates outside the mask pattern are searched in the comparison image 30. After the defect or the defects have been detected, for example, defect 22 in FIG. 9C, the defect detection at the position of the defect can be further provided without the mask pattern 32. A class image 70 of an exemplary defect, which can be imaged, for example, with higher resolution is shown in FIG. 10.

According to some embodiments, which can be combined with other embodiments, the class image view can be provided with an improved resolution, for example by re-scanning the desired FOV with an imaging charged particle beam microscope. The class image view can particularly be based upon that determined defect contour. Depending on the size of the defect contour, the class image or class image view can show an area including the defect and having a size with a predetermined ratio as compared to the size of the defect contour. Additionally or alternatively, a higher zoom image, which shows more defect details, can be provided as a class image. The local image can be a digital zoom of the defect image.

The multi-step approach including a defect selection with a mask pattern and a further defect re-detection of the selected defect without the mask pattern has several advantages. Such advantages may be tailored to display manufacturing conditions. The more pronounced pattern edge roughness in display manufacturing does not cause false defects. Due to the masking, the remaining areas, i.e. the unmasked regions or areas of an image, can be searched with a higher sensitivity for defects. Defect candidates partially covered by the mask or separated by the mask are corrected in contour by the second localized defect detection operation, i.e. the second defect detection without the mask pattern. Accordingly, a correct defect contour, i.e. defect contour without the mask, can be provided, which is beneficial for defect type classification. A correct defect contour, e.g. a defect detection without the mask pattern, allows to determine the real defect area and the real defect size.

In light of the above, some embodiments, which can be combined with other embodiments described herein, include generating a defect image of a portion of the large area substrate, the portion including a defect; generating a reference image corresponding to the defect image; determining a mask pattern based on the reference image; comparing the defect image and the reference image in regions outside the mask pattern to detect the defect; and redetecting the defect without the mask pattern to generate the electron beam image data.

While the foregoing is directed to some embodiments, other and further embodiments may be devised without departing from the basic scope thereof, and the scope thereof is determined by the claims that follow.

1. A method for defect classification, comprising:
storing a plurality of defect classes in terms of a plurality of classification rules in a multi-dimensional feature space, wherein the plurality of classification rules, for each defect class of the plurality of defect classes, defines in the multi-dimensional feature space a boundary of a region associated with the defect class;
receiving one or more electron beam image data associated with a plurality of defects detected in one or more display devices on a large area substrate under inspection;
applying, by a processor, an automatic classifier to the electron beam image data, the automatic classifier based on the plurality of classification rules; and
identifying the plurality of defects each classified with at least a first level of confidence based on at least one confidence threshold.

2. The method of claim 1, wherein the one or more electron beam image data is received in a first data format and is converted, by an interface algorithm, to a second data format for applying the automatic classifier.

3. The method of claim 2, wherein the first data format comprises a reference image and a defect image.

4. The method of claim 3, wherein the first data format further includes a class image.

5. The method of claim 2, further comprising:
adding, by the interface algorithm, a defect classification for each defect of the plurality of defects identified with at least the first level of confidence to the first data format.

6. The method of claim 1, further comprising:
generating a defect image of a portion of the large area substrate, the portion including a defect;
generating a reference image corresponding to the defect image; determining a mask pattern based on the reference image;
comparing the defect image and the reference image in regions outside the mask pattern to detect the defect; and
redetecting the defect without the mask pattern to generate the electron beam image data.

7. The method of claim 1, further comprising:
loading a large area substrate having one or more structures of the one or more display devices from a first production chamber into a vacuum chamber having an electron beam microscope coupled to the vacuum chamber configured to measure electron beam images for the one or more electron beam image data; and
loading the large area substrate from the vacuum chamber directly or indirectly into a second production chamber.

8. The method of claim 7, further comprising:
loading the large area substrate to a repair station before loading the large area substrate into the second production chamber.

9. The method of claim 1, further comprising:
measuring the one or more display devices with at least one of an automated optical inspection tool or an electron beam test tool to obtain a plurality of positions associated with the plurality of defects.

10. The method of claim 9, further comprising:
compensating a defect location offset for each of the plurality of positions.

11. The method of claim 1, further comprising:
providing electron beam image data to an operator for defects classified below the first level of confidence, wherein the first level of confidence being indicative of the defect being located in an overlap area between respective boundaries of at least two of the plurality of defect classes and/or outside a boundary of a single-class classifier.

12. The method of claim 1, wherein applying the automatic classifier comprises:
applying a multi-class classifier to the electron beam image data to classify the plurality of defects; and
applying a single-class classifier to identify the plurality of defects with the at least one confidence threshold.

13. The method of claim 12, further comprising:
setting a purity level and/or a confidence threshold to adapt a rejection rate.

14. A method of generating a plurality of classification rules, comprising:
receiving a plurality of electron beam image data associated with a plurality of defects detected in one or more display devices on a large area substrate;
receiving defect classes, each defect class associated with one or more of the plurality of electron beam image data; and
generating the plurality of classification rules in a multi-dimensional feature space, wherein the plurality of classification rules, for each defect class of a plurality of defect classes, defines in the multi-dimensional feature space a boundary of a region associated with the defect class.

15. The method of claim 14, further comprising:
converting, by an interface algorithm, the plurality of electron beam image data from a first data format to a second data format before generating the plurality of classification rules.

16. The method of claim 14, wherein the first data format comprises a reference image, a defect image, and a class image.

17. An automated defect classification system, comprising:
a memory comprising instructions and a processor, wherein the instructions, when executed by the processor, cause the automated defect classification system to execute a method according to claim 1.

18. An automated defect classification system, comprising:
a memory comprising instructions and a processor, wherein the instructions, when executed by the processor, cause the automated defect classification system to execute a method according to claim 14.
